(19) United States
(12) Patent Application Publication
(10) Pub. No.: US 2025/0284844 A1
(43) Pub. Date: Sep. 11, 2025

(54) ELECTRONIC SYSTEM AND METHOD FOR MANAGING ELECTRONIC SYSTEM

(71) Applicant: Samsung Electronics Co., Ltd., Suwon-si (KR)

(72) Inventors: Eunsoo PARK, Suwon-si (KR); Seungheon LEE, Suwon-si (KR); Jaepyo LEE, Suwon-si (KR); Taewoo LEE, Suwon-si (KR); Hyeokyoon CHANG, Suwon-si (KR)

(21) Appl. No.: 19/220,646

(22) Filed: May 28, 2025

Related U.S. Application Data
(63) Continuation of application No. PCT/KR2023/020797, filed on Dec. 15, 2023.

(30) Foreign Application Priority Data
Dec. 19, 2022 (KR) 10-2022-0177827
Jan. 11, 2023 (KR) 10-2023-0004163

(51) Int. Cl. G06F 21/62; G06F 11/14; G06F 16/25

(52) U.S. Cl. CPC G06F 21/6245; G06F 11/1451; G06F 16/254; G06F 2201/80

(57) ABSTRACT

An electronic system is provided. The electronic system includes a database, a data warehouse, and a management server, wherein the management server comprises memory storing one or more computer programs and one or more processors communicatively coupled to the memory, and wherein the one or more computer programs include computer-executable instructions that, when executed by the one or more processors individually or collectively, cause the management server to identify a change event related to private information stored in the data warehouse, extract first data required to be changed according to the change event in data including the private information stored in the database, based on the change event being identified, store the first data in a buffer corresponding to a first table of the data warehouse and a first buffer corresponding to a first warehouse table of the data warehouse, and suspend processing on the first data stored in the first buffer, perform processing on snapshot data obtained from a backup image of the data including the private information and store the processed snapshot data in the first warehouse table, based on the processed snapshot data being stored in the first warehouse table, perform processing on the first data stored in the first buffer and update the first warehouse table based on the processed first data, and based on the first data stored in the first buffer meeting a designated condition after the processing on the first data is performed, replace the first table with the first warehouse table.

### CROSS-REFERENCE TO RELATED APPLICATION(S)

This application is a continuation application, claiming priority under 35 U.S.C. § 365 (c), of an International application No. PCT/KR2023/020797, filed on Dec. 15, 2023, which is based on and claims the benefit of a Korean patent application number 10-2022-0177827, filed on Dec. 19, 2022, in the Korean Intellectual Property Office, and of a Korean patent application number 10-2023-0004163, filed on Jan. 11, 2023, in the Korean Intellectual Property Office, the disclosure of each of which is incorporated by reference herein in its entirety.

### BACKGROUND

### 1. Field

The disclosure relates to an electronic system and a method for managing the electronic system.

### 2. Description of Related Art

As the utilization of big data has increased recently, big data service providers collect and utilize various data from individuals, organizations, etc. Data users may search for and store desired data through big data services provided by big data service providers via big data analysis servers.

In managing a database that stores big data, a server that manages big data may retrieve data containing a user's private information from a big data platform and store and manage it. In this case, the management standards or methods of private information may change according to the policies or regulations established by the government or organization.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic system and method for managing the electronic system.

Additional aspects will be set forth in part in the description which follows and, in part, will be apparent from the description, or may be learned by practice of the presented embodiments.

In accordance with an aspect of the disclosure, an electronic system is provided. The electronic system includes a database a data warehouse, and a management server, wherein the management server comprises memory storing one or more computer programs and one or more processors communicatively coupled to the memory, and wherein the one or more computer programs include computer-executable instructions that, when executed by the one or more processors individually or collectively, cause the management server to identify a change event related to private information stored in the data warehouse, extract first data required to be changed according to the change event in data including the private information stored in the database based on the change event being identified, store the first data in a buffer corresponding to a first table of the data warehouse and a first buffer corresponding to a first warehouse table of the data warehouse and suspend processing on the first data stored in the first buffer, perform processing on snapshot data obtained from a backup image of the data including the private information and store the processed snapshot data in the first warehouse table, based on the processed snapshot data being stored in the first warehouse table, perform processing on the first data stored in the first buffer and update the first warehouse table based on the processed first data, and based on the first data stored in the first buffer meeting a designated condition after the processing on the first data is performed, replace the first table with the first warehouse table.

In accordance with another aspect of the disclosure, a method for managing an electronic system by a management server is provided. The method includes identifying, by the management server, a change event related to private information stored in a data warehouse of the electronic system, extracting, by the management server, first data required to be changed according to the change event in data including the private information stored in a database of the electronic system based on the change event being identified, storing, by the management server, the first data in a buffer corresponding to a first table of the data warehouse and a first buffer corresponding to a first warehouse table of the data warehouse and suspending processing on the first data stored in the first buffer, performing, by the management server, processing on snapshot data obtained from a backup image of the data including the private information and storing the processed snapshot data in the first warehouse table of the data warehouse, based on the processed snapshot data being stored in the first warehouse table, performing, by the management server, processing on the first data stored in the first buffer and updating the first warehouse table based on the processed first data, and based on the first data stored in the first buffer meeting a designated condition after the processing on the first data is performed, replacing, by the management server, the first table with the first warehouse table.

In accordance with another aspect of the disclosure, one or more non-transitory computer-readable recording media storing one or more computer programs including computer-executable instructions that, when executed by one or more processors of a management server of an electronic system individually or collectively, cause the electronic system to perform operations are provided. The operations include identifying, by the management server, a change event related to private information stored in a data warehouse of an electronic system by a management server of the electronic system, extracting, by the management server, first data required to be changed according to the change event in data including the private information stored in a database of the electronic system based on the change event being identified, storing, by the management server, the first data in a buffer corresponding to a first table of the data warehouse and a first buffer corresponding to a first warehouse table of the data warehouse and suspending processing on the first data stored in the first buffer, performing, by the management server, processing on snapshot data obtained from a backup image of the data including the private information and storing the processed snapshot data in the first warehouse table of the data warehouse, based on the processed snapshot data being stored in the first warehouse table, performing, by the management server, processing on the first data stored in the first buffer and updating the first warehouse table based on the processed first data, and based on the first data stored in the first buffer meeting a designated condition after the processing on the first data is performed, replacing, by the management server, the first table with the first warehouse table.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2 is a view schematically illustrating an electronic system according to an embodiment of the disclosure;

FIG. 3 is a view illustrating operations of an electronic system according to an embodiment of the disclosure;

FIG. 4 is a view illustrating operations of an electronic system according to an embodiment of the disclosure;

FIG. 5 is a flowchart illustrating a method for managing an electronic system according to an embodiment of the disclosure;

FIG. 6 is a flowchart illustrating a method for a management server to load CDC data into a buffer corresponding to a new warehouse table according to an embodiment of the disclosure;

FIG. 7 is a flowchart illustrating a method for a management server to load snapshot data into a new warehouse table according to an embodiment of the disclosure;

FIG. 8 is a flowchart illustrating a method for a management server to replace an existing table with a new warehouse table according to an embodiment of the disclosure;

FIGS. 9A, 9B, and 9C are views illustrating a method for updating a warehouse table using CDC data according to various embodiments of the disclosure;

FIGS. 10A, 10B, and 10C are views illustrating a method for updating a warehouse table using CDC data when an event of changing private information is identified according to various embodiments of the disclosure; and

FIG. 11 is a view illustrating a method for updating a warehouse table using CDC data when an event of changing private information is identified according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces,

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

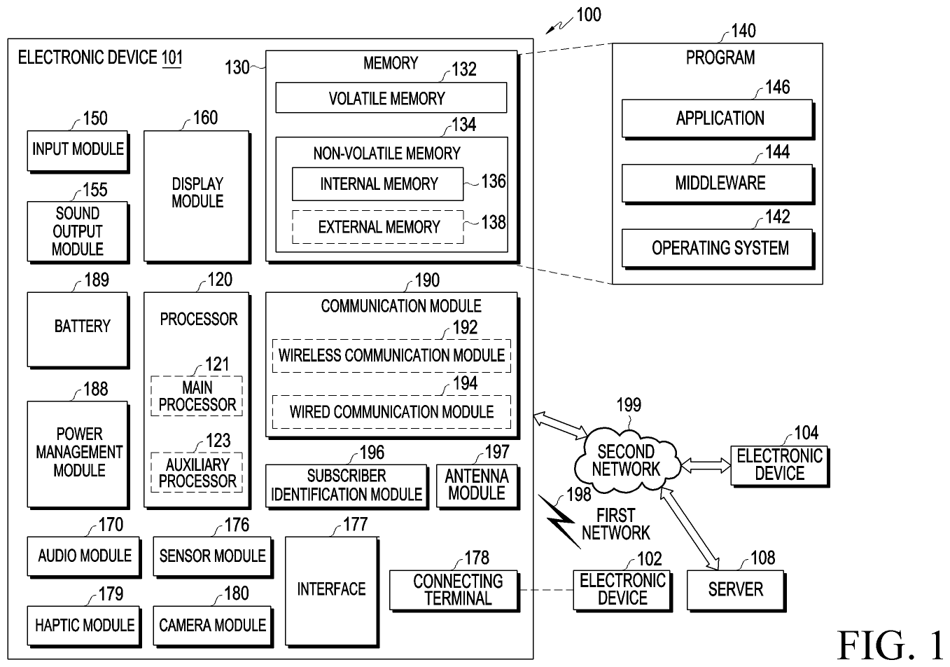

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth-generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

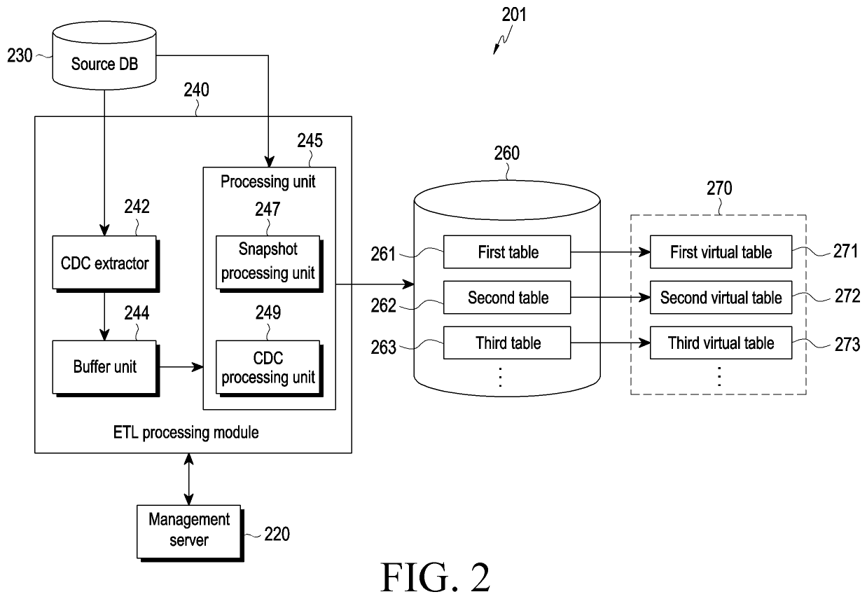

FIG. 2 is a view schematically illustrating an electronic system according to an embodiment of the disclosure.

Referring to FIG. 2, according to an embodiment, an electronic system 201 may include a management server 220, a source database (DB) 230, an ETL processing module 240, and a data warehouse 260. For example, the electronic system 201 may be implemented as a cloud platform. For example, the electronic system 201 may be implemented as a virtual private cloud (VPC).

According to an embodiment, the source DB 230 may store data collected through various paths. For example, the source DB 230 may be implemented as at least one storage device. For example, the source DB 230 may store original data. For example, the source DB 230 may store data including private information. In this case, the data including the private information may be original data that has not been processed or treated according to a policy for the private information.

According to an embodiment, the data warehouse 260 may store data obtained from the source DB. For example, the data warehouse 260 may be implemented as at least one storage device. The data warehouse 260 may provide stored data according to the user's request (e.g., query). For example, the data warehouse 260 may store data including private information. In this case, the data including the private information may be data obtained by performing a processing or treatment task on the original data according to the policy on the private information. For example, the processing or treatment task may include an operation of masking or filtering at least a part of private information. For example, the masking operation may include an operation of changing the corresponding data to an arbitrary value so that at least part of the original data (or private information) may not be identified. The filtering operation may include an operation of excluding at least part of the original data (or private information) from the loading target (or storage target) of the data warehouse 260.

According to an embodiment, the data warehouse 260 may include a plurality of tables (e.g., a first table 261, a second table 262, and a third table 263). The data warehouse 260 may store data of the plurality of tables (e.g., 261, 262, and 263). For example, each of the plurality of tables (e.g., 261, 262, and 263) may store related data.

According to an embodiment, the virtual table 270 may mean a virtual table connected to the data warehouse 260. For example, the virtual table 270 may be a virtual table for the user to identify information stored in the data warehouse 260. For example, the virtual table 270 may be configured to access a plurality of tables (e.g., 261, 262, and 263) included in the data warehouse 260 based on the user's request (e.g., query). For example, the virtual table 270 may be supported by software or separate hardware for accessing the data warehouse 260 based on the user's request.

According to an embodiment, the virtual table 270 may include a plurality of virtual tables 271, 272, and 273. Each of the plurality of virtual tables 271, 272, and 273 may be connected to each of the tables 261, 262, and 263 of the data warehouse 260. For example, a pointer of a specific virtual table may indicate a specific table. For example, a first virtual table 271 may correspond to a first table 261, a second virtual table 272 may correspond to a second table 262, and a third virtual table 273 may correspond to a third table 263.

According to an embodiment, the management server 220 may control or manage the overall operation of the electronic system 201. For example, the management server 220 may control the ETL processing module 240 to manage data stored in the source DB 230 and the data warehouse 260. For example, the management server 220 may be implemented to be identical or similar to the electronic device 101, 102, or 104 or the server 108 of FIG. 1.

According to an embodiment, the management server 220 may identify a change event related to private information stored in the data warehouse 260. For example, the change event may mean an event that changes a management method or storage method of at least part of private information. For example, the change event may include a policy change related to the private information (e.g., a policy change issued by a government or institution).

According to an embodiment, if the change event is identified, the management server 220 may change or update the private information stored in the data warehouse 260 using data including the private information stored in the source DB through the ETL processing module 240. At this time, the management server 220 may change or update the private information stored in the data warehouse 260 according to the change event (e.g., policy change in private information).

According to an embodiment, the ETL processing module 240 may process (e.g., extract, transform, or load) data (e.g., CDC data and snapshot data) between the source DB 230 and the data warehouse 260. The ETL processing module 240 may be implemented as a plurality of pieces of hardware configured to perform the processing operation. The ETL processing module 240 may be implemented as a cloud including a plurality of pieces of hardware configured to perform the above processing operation. For example, the ETL processing module 240 may be implemented as an ETL pipeline.

According to an embodiment, the ETL processing module 240 may include a CDC extractor 242, a buffer unit 244, and a processing unit 245. The CDC extractor 242 may extract CDC data required to be changed in the data stored in the source DB 230, based on the change event. Further, the CDC extractor 242 may transmit CDC data to the buffer unit 244. For example, the CDC extractor 242 may transmit CDC data to each of a plurality of buffers included in the buffer unit 244.

According to an embodiment, the buffer unit 244 may store CDC data extracted from the CDC extractor 242. Further, the buffer unit 244 may provide the stored CDC data to the processing unit 245. For example, the buffer unit 244 may include a plurality of buffers. For example, the plurality of buffers may be implemented as a plurality of pieces of hardware (e.g., storage devices). For example, the plurality of buffers respectively may correspond to the plurality of tables included in the data warehouse 260. For example, the buffer unit 244 may include a first buffer for storing data to be provided to the first table 261, a second buffer for storing data to be provided to the second table 262, and a third buffer for storing data to be provided to the third table 263.

According to an embodiment, the processing unit 245 may perform processing on the snapshot data and CDC data, and provide the processed snapshot data and CDC data to the data warehouse 260. For example, the processing unit 245 may include a snapshot processing unit 247 and a CDC processing unit 249.

According to an embodiment, the snapshot processing unit 247 may perform processing on the snapshot data obtained by copying the original data stored in the source DB 230, and may provide the processed snapshot data to the data warehouse 260. For example, the processing on the snapshot data may include an operation of masking or filtering private information included in the snapshot data. Further, the processing on the snapshot data may include an operation of decoding the snapshot data into data that may be loaded in data warehouse 260.

According to an embodiment, the CDC processing unit 249 may perform processing on the CDC data provided from the buffer unit 244 and provide the processed CDC data to the data warehouse 260. For example, the processing on the CDC data may include an operation of masking or filtering private information included in the CDC data.

According to an embodiment, the data warehouse 260 may update data including private information using the snapshot data and CDC data provided from the processing unit 245.

According to an embodiment, if a policy change related to the private information is identified, the data warehouse 260 should store or load data including the private information suitable for the changed policy. For example, previously stored data including the private information may be newly stored according to the changed policy or may be changed according to the changed policy. In this case, a change date capture (CDC) technique that collects only the changed portions of the data and stores or loads the collected changed portions in the data warehouse 260 may be used. For example, the CDC technique may refer to a technique that collects original data once at first and then, if a change in the data occurs, obtains only the data of the changed portion and updates the original data. However, the data warehouse 260 may not store or load the original data of the data including the private information necessary when using the CDC technique. For example, the data warehouse 260 may only store data in which at least part of the private information has previously been masked or filtered from the source DB 230. In other words, the data warehouse 260 may not store or load the original data to which masking or filtering is not applied. Accordingly, the data warehouse 260 may be required to re-collect the original data from the source DB 230 in order to use the CDC technique.

However, in the conventional electronic system, when the data warehouse 260 re-collects the original data from the source DB 230, snapshot data for collecting the original data should be obtained. In this case, if the frequency of obtaining snapshot data increases, the load on the electronic system may be excessively increased. Further, when the operation of obtaining snapshot data is performed, all CDC data transmission operations (or streaming operations) between the source DB 230 and the data warehouse 260 may be stopped, and the data stored in the data warehouse 260 may not be updated.

The electronic system 201 of the disclosure may update data stored in the data warehouse 260 on a per-table basis. Accordingly, when a change event such as a policy change in private information is identified, the electronic system 201 of the disclosure may update the data stored in the data warehouse 260 using the CDC data while obtaining the snapshot data. In other words, when updating a specific table included in the data warehouse 260 using the CDC data, the transmission operation (or streaming operation) of CDC data of other tables included in the data warehouse 260 may not be stopped. Further, the electronic system of the disclosure may, as compared with the conventional art, reduce the load generated when changing data stored in the data warehouse 260 according to a change event such as a policy change in the private information.

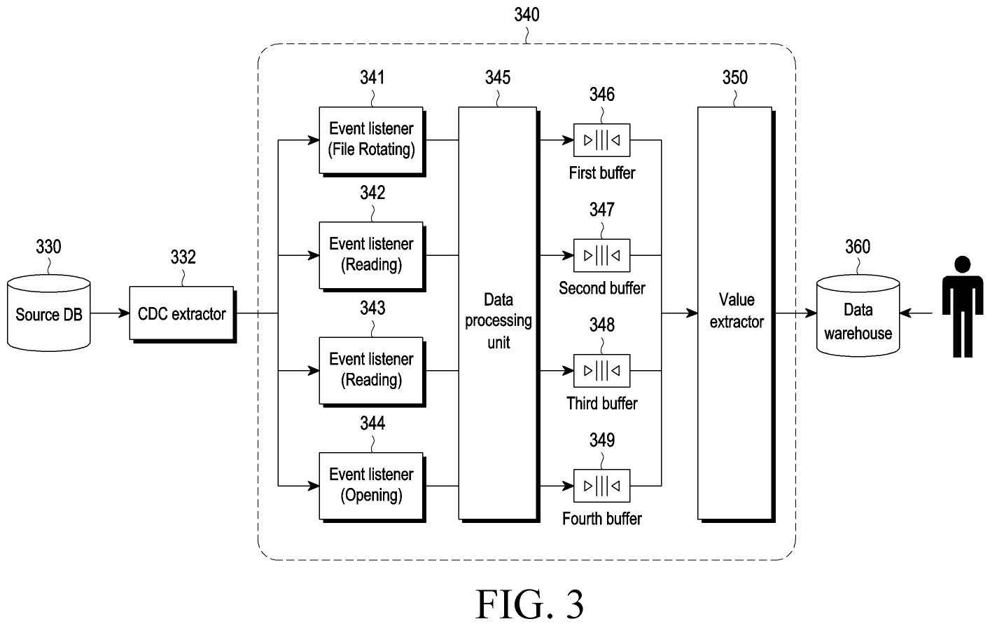

FIG. 3 is a view illustrating operations of an electronic system according to an embodiment of the disclosure.

Referring to FIG. 3, according to a comparative embodiment, an electronic device may include a source DB 330, a CDC extractor 332, an ETL processing module 340, and a data warehouse 360. For example, the source DB 330 may be implemented to be identical or similar to the source DB 230 of FIG. 2. Further, the CDC extractor 332 may be implemented to be identical or similar to the CDC extractor 242 of FIG. 2.

According to the comparative embodiment, the ETL processing module 340 may include a plurality of event listeners 341, 342, 343, and 344, a data processing unit 345, a plurality of buffers 346, 347, 348, and 349 and a value extractor 350.

According to the comparative embodiment, the plurality of event listeners 341, 342, 343, and 344 may be configured to perform a designated function. For example, the plurality of event listeners 341, 342, 343, and 344 may be configured to perform any one of file rotating, reading, or opening operations on CDC data provided from CDC extractor 332. The plurality of event listeners 341, 342, 343, and 344 may provide CDC data on which the designated function is performed to the data processing unit 345. The data processing unit 345 may provide the CDC data processed according to a policy change in the private information to the plurality of buffers 346, 347, 348, and 349. For example, the CDC file where the designated function (e.g., file rotating) has been performed by the first event listener 341 may be stored in the first buffer 346, the CDC file where the designated function (e.g., reading) has been performed by the second event listener 342 may be stored in the second buffer 347, the CDC file where the designated function (e.g., reading) has been performed by the third event listener 343 may be stored in the third buffer 348, and the CDC file where the designated function (e.g., opening) has been performed by the fourth event listener 344 may be stored in the fourth buffer 349. The plurality of buffers 346, 347, 348, and 349 may provide the processed CDC files to the value extractor 350. The value extractor 350 may sort the processed CDC files and store or load them in the data warehouse 360.

According to the comparative example, the conventional electronic system may statically have the event listeners 341, 342, 343, and 344 and the data processing unit 345 that perform a function suitable for the purpose. In other words, the conventional electronic system may not separately process CDC data for each table included in the data warehouse.

According to the comparative embodiment, the conventional electronic system may obtain snapshot data obtained by copying the original data when the data warehouse 360 re-collects the original data from the source DB 330. However, since CDC data is not processed for each table included in the data warehouse, when data stored in a specific table is updated, all CDC streaming operations in the data warehouse 360 may be stopped. Accordingly, data of the data warehouse 360 may not be efficiently updated.

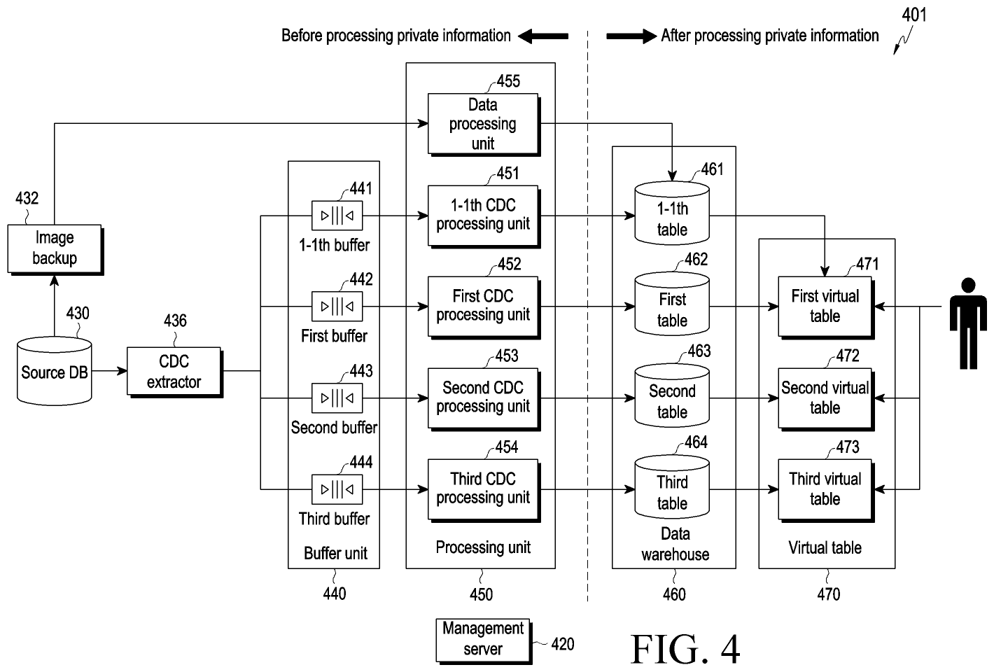

FIG. 4 is a view illustrating operations of an electronic system according to an embodiment of the disclosure.

Referring to FIG. 4, an electronic system 401 may include a source DB 430, an image backup device 432, a CDC extractor 436, a buffer unit 440, a processing unit 450, and a data warehouse 460.

According to an embodiment, the electronic system 401 may be implemented to be identical or similar to the electronic system 201 described in FIG. 2. For example, the management server 420 may be implemented to be identical or similar to the management server 220 described in FIG. 2. The source DB 430 may be implemented to be identical or similar to the source DB 230 described in FIG. 2. The CDC extractor 436 may be implemented to be identical or similar to the CDC extractor 242 described in FIG. 2. The buffer unit 440 may be implemented to be identical or similar to the buffer unit 244 described in FIG. 2. The processing unit 450 may be implemented to be identical or similar to the processing unit 245 described in FIG. 2. The data warehouse 460 may be implemented to be identical or similar to the data warehouse 260 described in FIG. 2. The virtual table 470 may be implemented to be identical or similar to the virtual table 270 described in FIG. 2.

According to an embodiment, the image backup device 432 may generate and store a backup image for data stored in the source DB 430 periodically or aperiodically.

Meanwhile, the following description of the operations of the electronic system 401 focuses primarily on an embodiment of updating data stored in the first table 462 included in the data warehouse 460. However, this is merely for ease of description, and the technical spirit of the disclosure is not limited thereto.

According to an embodiment, the management server 420 may identify a change event related to private information stored in the data warehouse 460. For example, the change event may include a policy change related to private information.

According to an embodiment, if the change event is identified, the management server 420 may control the CDC extractor 436 to extract the first data required to be changed according to the change event in data (e.g., original data) including private information stored in the source DB 430. For example, the first data may be CDC data that needs to be changed in the data warehouse 460 according to a change event (e.g., policy change in the private information).

According to an embodiment, the management server 420 may generate a new 1-1th buffer 441 corresponding to the new first warehouse table 461 of the data warehouse 460 in the buffer unit 440 based on identifying the change event.

According to an embodiment, the management server 420 may control the CDC extractor 436 to store the first data in the first buffer 442 corresponding to the first table 462 of the data warehouse 460 and the 1-1th buffer 441 corresponding to the first warehouse table 461 of the data warehouse 460. The management server 420 may suspend processing on the first data stored in the 1-1th buffer 441. For example, the 1-1th buffer 441 may not provide or distribute the stored first data to the 1-1th CDC processing unit 451.

According to an embodiment, the management server 420 may obtain a backup image of the original data including the private information stored in the image backup device 432 based on identifying the change event. The management server 420 may obtain or extract snapshot data from the backup image based on suspending processing on the first data stored in the 1-1th buffer 441. The management server 420 may provide or distribute snapshot data to the snapshot data processing unit 455. The snapshot data processing unit 455 may perform processing on the snapshot data. The snapshot data processing unit 455 may filter or mask private information included in the snapshot data. Further, the snapshot data processing unit 455 may perform a decoding operation so that snapshot data may be stored or loaded in the 1-1th table 461. The snapshot data processing unit 455 may store or load snapshot data where processing on private information has been performed in the 1-1th table.

According to an embodiment, if the processed snapshot data is stored in the 1-1th table 461 is stored, the management server 420 may control the 1-1th CDC processing unit 451 to perform processing on the first data stored in the 1-1th buffer 461. For example, the 1-1th CDC processing unit 451 may filter or mask private information included in the data. The 1-1th CDC processing unit 451 may provide or load the first data where the processing on the private information has been performed in the 1-1th table 461. The 1-1th table 461 may update the pre-stored snapshot data based on the first data. For example, the 1-1th table 461 may update the snapshot data by replaying the first data.

According to an embodiment, the management server 420 may identify whether the first data stored in the 1-1th buffer 461 meets a designated condition after processing on the first data is performed. For example, if the number of remaining first data stored in the 1-1th buffer 441 after at least part of the first data is processed and provided to the 1-1th table 461 is smaller than a designated value, the management server 420 may identify that the designated condition is met.

According to an embodiment, when it is identified that the first data stored in the 1-1th buffer 461 meets the designated condition, the management server 420 may replace the existing first table 462 with the 1-1th table 431. For example, the management server 420 may change the pointer of the first virtual table 471 to indicate the 1-1th table 461 instead of the first table 462. Thereafter, the management server 420 may delete or remove resources for the first table 462. For example, resources for the first table 462 may include the first buffer 442, the first CDC processing unit 452, and the first table 462.

According to an embodiment, the management server 420 may manage or control the second table 463 and the third table 464 included in the data warehouse 460 independently of the update operation of the first table 462. For example, the management server 420 may manage the second buffer 443, the second CDC processing unit 453, and the second virtual table 472 corresponding to the second table 463 independently of the update operation of the first table 462. Further, the management server 420 may manage the third buffer 444, the third CDC processing unit 454, and the third virtual table 473 corresponding to the third table 464 independently of the update operation of the first table 462. For example, the management server 420 may perform management or tasks on each of the plurality of tables included in the data warehouse 460 in parallel.

Through the above-described method, the electronic system 401 according to an embodiment may update data including private information included in the first table using the first data (or CDC data) without stopping the CDC streaming operation of other tables included in the data warehouse 460. Accordingly, the electronic system 401 may efficiently change data including private information stored in the data warehouse 460 according to a policy change in the private information as compared to the conventional one.

Through the above-described method, the electronic system 401 may provide a virtual table to reflect the source data to the data warehouse 460 when a snapshot for restoration (or re-collection) of the source data is required, such as a change in processing private information or a policy change in the private information. Further, the electronic system 401 may perform snapshot extraction processing and virtual table mapping change processing in parallel, performing CDC streaming processing without interruption while maintaining the data stored in the data warehouse 460 as the latest one.

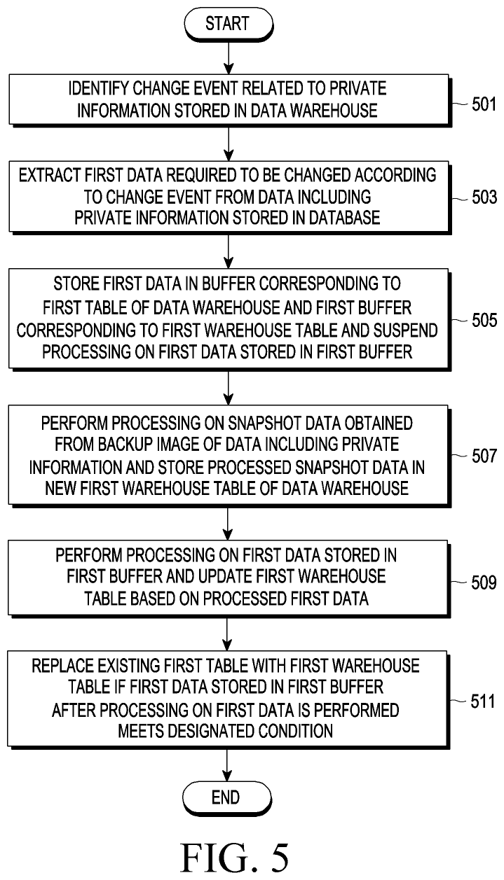

FIG. 5 is a flowchart illustrating a method for managing an electronic system according to an embodiment of the disclosure.

Referring to FIG. 5, according to an embodiment, in operation 501, the management server (e.g., the management server 420 of FIG. 4) may identify a change event related to private information stored in the data warehouse (e.g., the data warehouse 460 of FIG. 4). For example, the change event may include a policy change related to private information.

According to an embodiment, in operation 503, the management server 420 may extract first data required to be changed according to a change event in data (e.g., original data) including private information stored in a database (e.g., the source DB 430 of FIG. 4). For example, the first data may be CDC data including private information that needs to be changed according to a change event.

According to an embodiment, in operation 505, the management server 420 may store the first data in a buffer (e.g., 442 of FIG. 4) corresponding to the first table of the data warehouse 460, and a first buffer (e.g., 441 of FIG. 4) corresponding to the first warehouse table. The management server 420 may suspend processing on the first data stored in the first buffer 441. For example, the management server 420 may not provide or distribute the first data to the first table CDC processing unit (e.g., the 1-1th CDC processing unit 451).

According to an embodiment, in operation 507, the management server 420 may obtain snapshot data from a backup image of data (e.g., original data) including private information and perform processing (e.g., filtering or masking of private information) on the obtained snapshot data. The management server 420 may store the processed snapshot data in a new first warehouse table (e.g., the 1-1th table 461 of FIG. 4) of the data warehouse.

According to an embodiment, in operation 509, the management server 420 may perform processing (e.g., filtering or masking of private information) on the first data stored in the first buffer 441 and update the first warehouse table 461 based on the first data on which processing has been performed. For example, the management server 420 may add information included in the processed first data to the processed snapshot data stored in the first warehouse table 461.

According to an embodiment, in operation 511, the management server 420 may replace the existing first table 462 with the first warehouse table 461 if the first data stored in the first buffer after processing on the first data is performed meets the designated condition. For example, if the number of remaining first data stored in the 1-1th buffer 441 after at least part of the first data is provided to the first table CDC processing unit 451 through the first buffer 441 is smaller than a designated value, the management server 420 may identify that the designated condition is met. For example, the management server 420 may change the pointer of the first virtual table 471 to access the first warehouse table 461 instead of the first table 462 through the first virtual table (e.g., the first virtual table 471 of FIG. 4).

According to an embodiment, the management server 420 may delete or remove all resources for the existing first table 462 after replacing the existing first table 462 with the first warehouse table 461.

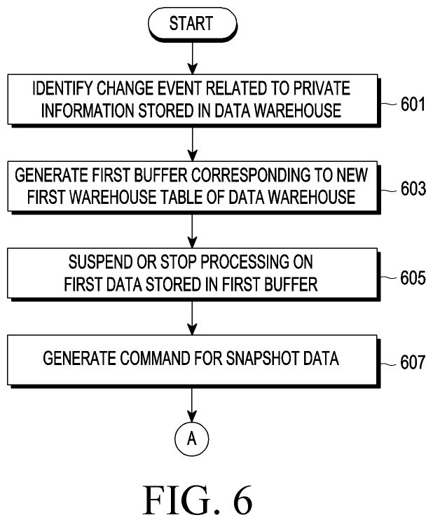

FIG. 6 is a flowchart illustrating a method for a management server to load CDC data into a buffer corresponding to a new warehouse table according to an embodiment of the disclosure.

Referring to FIG. 6, according to an embodiment, in operation 601, the management server (e.g., the management server 420 of FIG. 4) may identify a change event related to private information stored in the data warehouse (e.g., the data warehouse 460 of FIG. 4). For example, the change event may include a policy change related to private information.

According to an embodiment, in operation 603, the management server 420 may generate a first buffer (e.g., 441 of FIG. 4) corresponding to a new first warehouse table (e.g., 461 of FIG. 4) of the data warehouse 460.

According to an embodiment, in operation 605, the management server 420 may suspend or stop processing on the first data stored in the first buffer 441. For example, the management server 420 may not provide or distribute the first data to the first table CDC processing unit (e.g., 451 of FIG. 4). In this case, the management server 420 may determine an algorithm of the first table CDC processing unit 451 and apply the determined algorithm to the first table CDC processing unit 452.

According to an embodiment, in operation 607, the management server 420 may generate a command for obtaining snapshot data based on suspending processing on the first data stored in the first buffer 441. For example, the command may include a generation time of the first data that is first generated for the first warehouse table 461.

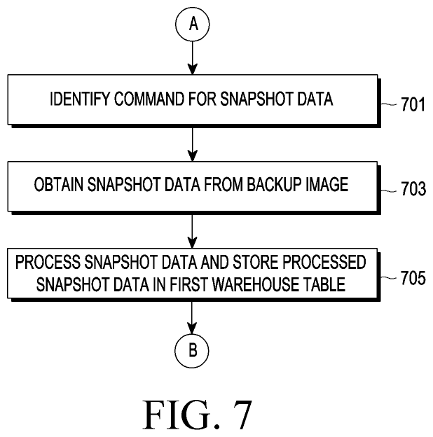

FIG. 7 is a flowchart illustrating a method for a management server to load snapshot data into a new warehouse table according to an embodiment of the disclosure.

Referring to FIG. 7, according to an embodiment, in operation 701, the management server (e.g., the management server 420 of FIG. 4) may identify a command for snapshot data. For example, the management server 420 may identify the first warehouse table 461 requiring snapshot data based on the command. Further, the management server 420 may identify the generation time of the first data based on the command and identify the most recently generated backup image with respect to the generation time of the first data.

According to an embodiment, in operation 703, the management server 420 may obtain snapshot data where the original data is copied from the backup image of the original data.

According to an embodiment, in operation 705, the management server 420 may process snapshot data and store or load the processed snapshot data in the first warehouse table 461. For example, the management server 420 may filter or mask private information included in the snapshot data through the snapshot data processing (e.g., 455 of FIG. 4).

According to an embodiment, if the snapshot data is stored or loaded in the first warehouse table 461, the management server 420 may issue a snapshot loading complete event.

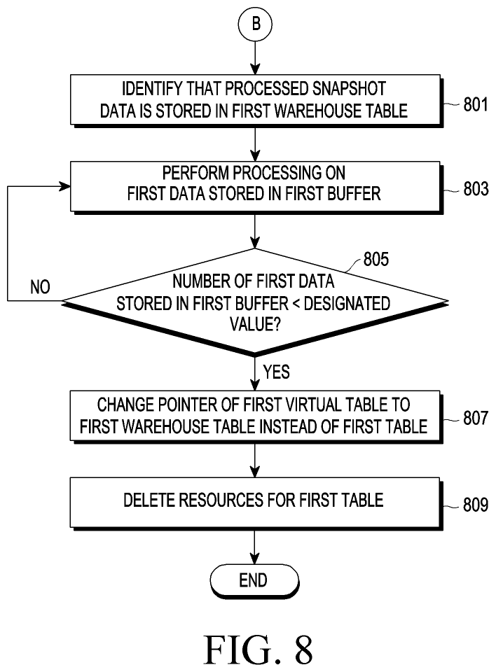

FIG. 8 is a flowchart illustrating a method for a management server to replace an existing table with a new warehouse table according to an embodiment of the disclosure.

Referring to FIG. 8, according to an embodiment, in operation 801, the management server (e.g., the management server 420 of FIG. 4) may identify that the processed snapshot data is stored in the first warehouse table (e.g., 461 of FIG. 4) based on the snapshot loading complete event.

According to an embodiment, in operation 803, the management server 420 may control the first table CDC processing unit (e.g., 451 of FIG. 4) to perform processing on the first data stored in the first buffer (e.g., 441 of FIG. 4) according to a change event (e.g., a newly changed private information policy). For example, the first table CDC processing unit 451 may filter or mask the private information included in the first data according to the newly changed private information policy. The processed first data may be provided to the first warehouse table 461. As the processed first data is provided to the first warehouse table 461, the number of first data stored in the first buffer 441 may be reduced.

According to an embodiment, in operation 805, the management server 420 may identify whether the number of first data stored in the first buffer 441 is smaller than a designated value. For example, the designated value may be automatically determined by the management server 420 or may be determined by the user.

According to an embodiment, if it is identified that the number of first data stored in the first buffer 441 is not smaller than the designated value (No in operation 805), the management server 420 may continue to perform processing on the first data stored in the first buffer 441 and provide it to the first warehouse table 461.

According to an embodiment, if it is identified that the number of first data stored in the first buffer 441 is smaller than the designated value (Yes in operation 805), in operation 807, the management server 420 may change the pointer of the first virtual table (e.g., 471 of FIG. 4) to the first warehouse table 461 instead of the first table (e.g., 462 of FIG. 4). Accordingly, the first table 462 may be changed to a new first warehouse table 461.

According to an embodiment, in operation 809, the management server 420 may delete or remove resources for the first table 462.

According to an embodiment, the operations of FIG. 6, the operations of FIG. 7, and the operations of FIG. 8 described above may be performed in parallel. Accordingly, the electronic system 401 may efficiently change or update data (e.g., data including private information) stored in the data warehouse 460. Further, even if the private information policy is changed, the electronic system 401 may efficiently change the data including the private information stored in the data warehouse 460 to fit the new private information policy.

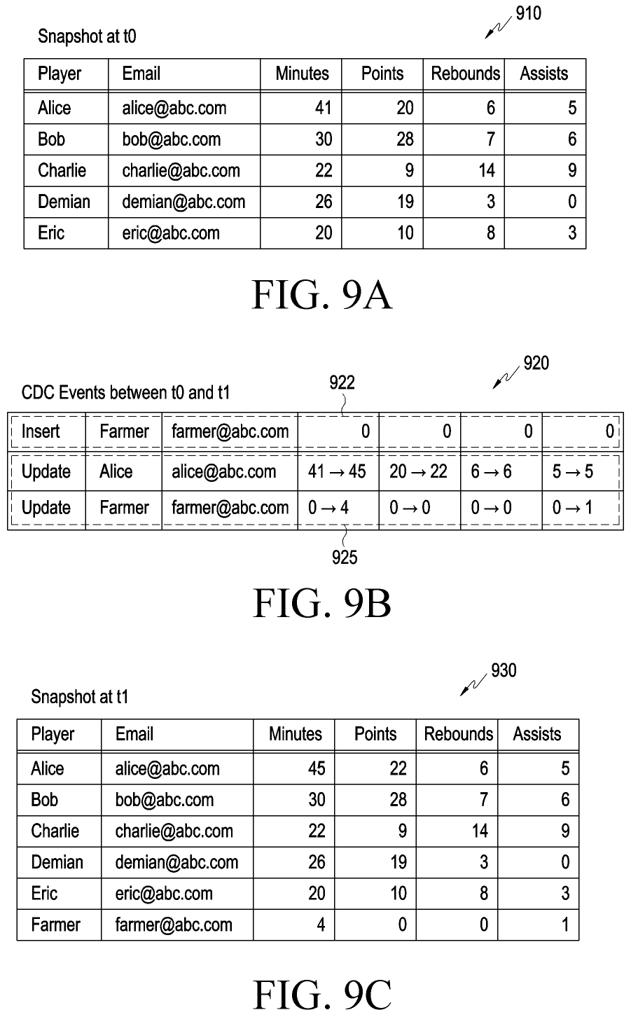

FIGS. 9A, 9B, and 9C are views illustrating a method for updating a warehouse table using CDC data according to various embodiments of the disclosure.

Referring to FIG. 9A, the management server (e.g., 420 of FIG. 4) may generate a snapshot command to obtain snapshot data 910 for the first table of the data warehouse (e.g., 460 of FIG. 4) at a first time 10. For example, the snapshot data 910 may include private information (e.g., information about the player names, e-mails, and basketball records). For example, the private information included in the snapshot data 910 may not be filtered or masked according to the policy of the private information.

Referring to FIG. 9B, the management server 420 may obtain CDC data 920 indicating changed data from the existing first table at a second time t1 after the first time through the CDC extractor (e.g., 436 of FIG. 4). For example, the CDC data 920 may include additional data 922 and update data 925. For example, the private information included in the CDC data 920 may not be filtered or masked according to the policy of the private information.

Referring to FIG. 9C, the management server 420 may obtain the snapshot data 930 at the second time t1 by updating the snapshot data 910 obtained at the first time 10 with the CDC data 920. The management server 420 may further add a row corresponding to the additional data 922 to the snapshot data 910 at the first time to, and update the records based on the update data 925. The management server 420 may store the snapshot data 930 in the first table (e.g., 461 of FIG. 4) of the data warehouse at the second time t1.

According to the above-described methods, the management server 420 may update the data of the data warehouse 460 for each table.

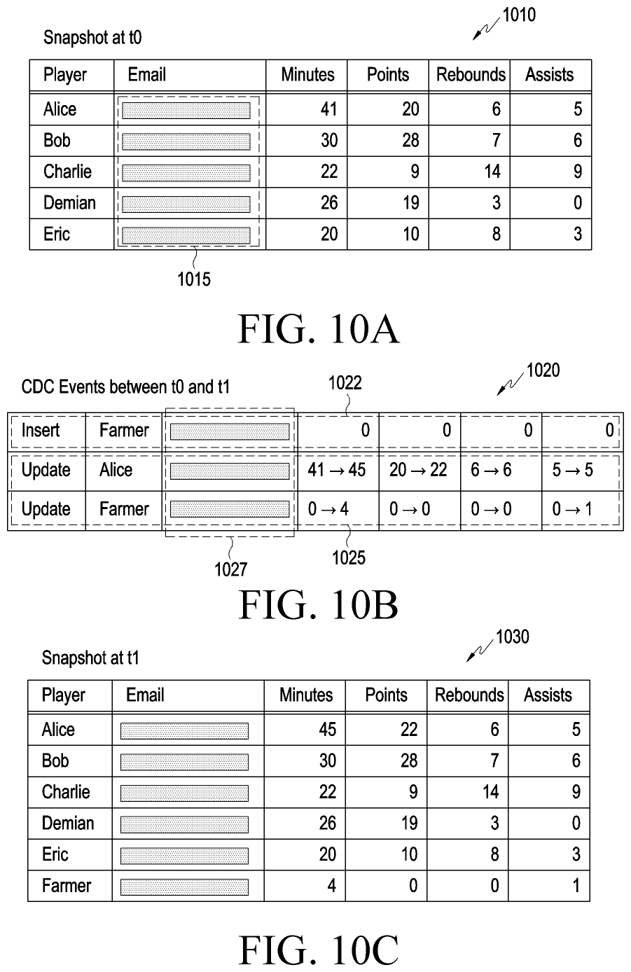

FIGS. 10A, 10B, and 10C are views illustrating a method for updating a warehouse table using CDC data when an event of changing private information is identified according to various embodiments of the disclosure.

Referring to FIG. 10A, the management server (e.g., 420 of FIG. 4) may generate a snapshot command to obtain snapshot data 910 for the first table of the data warehouse (e.g., 460 of FIG. 4) at the first time 10. For example, the snapshot data 910 may include private information (e.g., information about the player names, e-mails, and basketball records). For example, the information 1015 about the email among the private information included in the snapshot data 1010 may be filtered or masked according to the policy of the private information.

Referring to FIG. 10B, the management server 420 may obtain CDC data 1020 indicating changed data from the existing first table at the second time t1 after the first time through the CDC extractor (e.g., 436 of FIG. 4). For example, the CDC data 1020 may include additional data 1022 and update data 1025. For example, according to the policy of private information, the information 1027 about the email among the private information included in the CDC data 1020 may be filtered or masked.

Referring to FIG. 10C, the management server 420 may obtain snapshot data 1030 at the second time t1 by updating the CDC data 1020 to the snapshot data 1010 obtained at the first time t0. The management server 420 may further add a row corresponding to the additional data 1022 to the snapshot data 1010 at the first time to, and update the records based on the update data 1025. For example, the information about the email among the private information included in the snapshot data 1030 at the second time t1 may be filtered or masked according to the policy of the private information. The management server 420 may store the snapshot data 1030 in the first table (e.g., 461 of FIG. 4) of the data warehouse at the second time t1.

According to the above-described methods, the management server 420 may update the data of the data warehouse 460 for each table. Further, even if the private information policy is changed, the management server 420 may change the private information in the data warehouse 460 according to the new private information policy using CDC data.

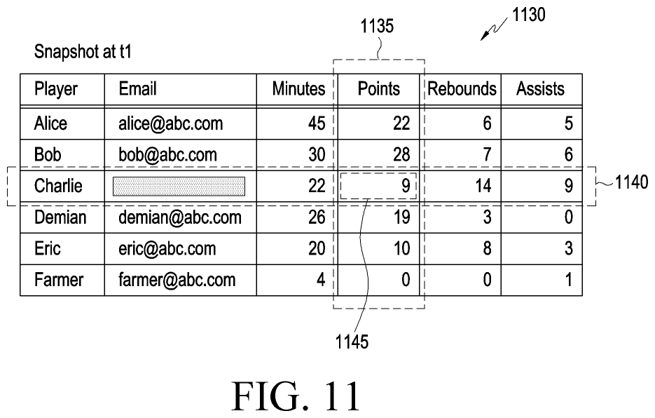

FIG. 11 is a view illustrating a method for updating a warehouse table using CDC data when an event of changing private information is identified according to an embodiment of the disclosure.

Referring to FIG. 11, according to an embodiment, the management server 420 may obtain the snapshot data 1130 at the second time t1 by updating the snapshot data (e.g., 910) obtained at the first time 10 with the CDC data (e.g., 920). The management server 420 may further add a row corresponding to the additional data 1022 to the snapshot data 1010 at the first time t0, and update the records based on the update data 1025.

According to an embodiment, the management server 420 may update the snapshot data 1130 at the second time t1 in units of rows, columns, or cells as well as in units of tables according to the policy of private information. For example, the management server 420 may update each row, column, or cell that needs to be changed according to a change in the policy of private information. For example, the management server 420 may apply masking or filtering only to private information corresponding to data that meets a specific condition in the snapshot data 1130. For example, the management server 420 may apply masking to private information (e.g., e-mail address) of the row 1140 where “Points” are smaller than 10 points among those who scored. Alternatively, the management server 420 may apply masking to private information (e.g., email address) of an individual (e.g., Charlie) who scores smaller than 10 points in the column 1135 for “Points” among those who scored. Alternatively, the management server 420 may apply masking to private information (e.g., email address) of an individual (e.g., Charlie) corresponding to the cell 1145 where “Points” are smaller than 10 points among those who scored.

According to the above-described methods, the management server 420 may update the data of the data warehouse 460 for each row, column, or cell. Further, even if the private information policy is changed, the management server 420 may change the private information in the data warehouse 460 according to the new private information policy using CDC data.

An electronic system 201, 401 according to an embodiment may comprise a database 230, 430, a data warehouse 260, 460, and a management server 220, 420. The management server according to an embodiment may be configured to identify a change event related to private information stored in the data warehouse. The management server according to an embodiment may be configured to extract first data required to be changed according to the change event in data including the private information stored in the database if the change event is identified. The management server according to an embodiment may be configured to store the first data in a buffer corresponding to a first table of the data warehouse and a first buffer corresponding to a new first warehouse table of the data warehouse and suspend processing on the first data stored in the first buffer. The management server according to an embodiment may be configured to perform processing on snapshot data obtained from a backup image of the data including the private information and store the processed snapshot data in a new first warehouse table of the data warehouse. The management server according to an embodiment may be configured to, if the processed snapshot data is stored in the first warehouse table, perform processing on the first data stored in the first buffer and update the first warehouse table based on the processed first data. The management server according to an embodiment may be configured to, if the first data stored in the first buffer meets a designated condition after the processing on the first data is performed, replace the existing first table with the first warehouse table.

The management server according to an embodiment may be configured to change a pointer of a virtual table for a user to identify information stored in the data warehouse to the first warehouse table instead of the first table.

The management server according to an embodiment may be configured to delete resources for the first table.

The management server according to an embodiment may be configured to, if a number of the first data stored in the first buffer is smaller than a designated value after the processing on the first data is performed, identify that the designated condition is met.

The management server according to an embodiment may be configured to filter or mask the private information stored in the first data if the backup data is stored in the first warehouse table.

The management server according to an embodiment may be configured to provide the first data including the filtered or masked private information to the first warehouse table.

The management server according to an embodiment may be configured to obtain the backup image from the database based on identifying the change event.

The management server according to an embodiment may be configured to generate the first buffer for storing the first data based on identifying the change event.

The management server according to an embodiment may be configured to obtain the snapshot data from the backup image based on suspending the processing on the first data stored in the first buffer.

The change event according to an embodiment may include a policy change related to the private information.

A method for managing an electronic system 201, 401 by a management server 220, 420, according to an embodiment, may comprise identifying a change event related to private information stored in a data warehouse 260, 460 of the electronic system. The method for managing the electronic system according to an embodiment may comprise extracting first data required to be changed according to the change event in data including the private information stored in a database 230, 430 of the electronic system if the change event is identified. The method for managing the electronic system according to an embodiment may comprise storing the first data in a buffer corresponding to a first table of the data warehouse and a first buffer corresponding to a new first warehouse table of the data warehouse and suspending processing on the first data stored in the first buffer. The method for managing the electronic system according to an embodiment may comprise performing processing on snapshot data obtained from a backup image of the data including the private information and storing the processed snapshot data in a new first warehouse table of the data warehouse. The method for managing the electronic system according to an embodiment may comprise, if the processed snapshot data is stored in the first warehouse table, performing processing on the first data stored in the first buffer and updating the first warehouse table based on the processed first data. The method for managing the electronic system according to an embodiment may comprise, if the first data stored in the first buffer meets a designated condition after the processing on the first data is performed, replacing the existing first table with the first warehouse table.

Replacing the first table with the first warehouse table according to an embodiment may include changing a pointer of a virtual table for a user to identify information stored in the data warehouse to the first warehouse table instead of the first table.

The method for managing the electronic system according to an embodiment may further comprise deleting resources for the first table.

The method for managing the electronic system according to an embodiment may further comprise, if a number of the first data stored in the first buffer is smaller than a designated value after the processing on the first data is performed, identifying that the designated condition is met.

Performing the processing on the first data according to an embodiment may include filtering or masking the private information stored in the first data if the backup data is stored in the first warehouse table.

Performing the processing on the first data according to an embodiment may include providing the first data including the filtered or masked private information to the first warehouse table.

The method for managing the electronic system according to an embodiment may further comprise obtaining the backup image from the database based on identifying the change event.

Storing the first data in the first buffer according to an embodiment may include generating the first buffer for storing the first data based on identifying the change event.

Performing the processing on the snapshot data according to an embodiment may include obtaining the snapshot data from the backup image based on suspending the processing on the first data stored in the first buffer.

A non-transitory recording medium 130 according to an embodiment may store a program capable of executing identifying a change event related to private information stored in a data warehouse 260, 460 of an electronic system by a management server 220, 420 of the electronic system 201, 401, extracting first data required to be changed according to the change event in data including the private information stored in a database 230, 430 of the electronic system if the change event is identified, storing the first data in a buffer corresponding to a first table of the data warehouse and a first buffer corresponding to a new first warehouse table of the data warehouse and suspending processing on the first data stored in the first buffer, performing processing on snapshot data obtained from a backup image of the data including the private information and storing the processed snapshot data in a new first warehouse table of the data warehouse, if the processed snapshot data is stored in the first warehouse table, performing processing on the first data stored in the first buffer and updating the first warehouse table based on the processed first data, and if the first data stored in the first buffer meets a designated condition after the processing on the first data is performed, replacing the existing first table with the first warehouse table.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic system, comprising:
a database;
a data warehouse; and
a management server, wherein the management server comprises memory storing one or more computer programs and one or more processors communicatively coupled to the memory, and
wherein the one or more computer programs include computer-executable instructions that, when executed by the one or more processors individually or collectively, cause the management server to:
identify a change event related to private information stored in the data warehouse,
extract first data required to be changed according to the change event in data including the private information stored in the database based on the change event being identified,
store the first data in a buffer corresponding to a first table of the data warehouse and a first buffer corresponding to a first warehouse table of the data warehouse and suspend processing on the first data stored in the first buffer,
perform processing on snapshot data obtained from a backup image of the data including the private information and store the processed snapshot data in the first warehouse table,
based on the processed snapshot data being stored in the first warehouse table, perform processing on the first data stored in the first buffer and update the first warehouse table based on the processed first data, and
based on the first data stored in the first buffer meeting a designated condition after the processing on the first data is performed, replace the first table with the first warehouse table.

2. The electronic system of claim 1, wherein the one or more computer programs further include computer-executable instructions that, when executed by the one or more processors individually or collectively, cause the management server to change a pointer of a virtual table for a user to identify information stored in the data warehouse to the first warehouse table instead of the first table.

3. The electronic system of claim 2, wherein the one or more computer programs further include computer-executable instructions that, when executed by the one or more processors individually or collectively, cause the management server to delete resources for the first table.

4. The electronic system of claim 1, wherein the one or more computer programs further include computer-executable instructions that, when executed by the one or more processors individually or collectively, cause the management server to, based on a number of the first data stored in the first buffer being smaller than a designated value after the processing on the first data is performed, identify that the designated condition is met.

5. The electronic system of claim 1, wherein the one or more computer programs further include computer-executable instructions that, when executed by the one or more processors individually or collectively, cause the management server to filter or mask the private information stored in the first data based on the backup data being stored in the first warehouse table.

6. The electronic system of claim 5, wherein the one or more computer programs further include computer-executable instructions that, when executed by the one or more processors individually or collectively, cause the management server to provide the first data including the filtered or masked private information to the first warehouse table.

7. The electronic system of claim 1, wherein the one or more computer programs further include computer-executable instructions that, when executed by the one or more processors individually or collectively, cause the management server to obtain the backup image from the database based on identifying the change event.

8. The electronic system of claim 1, wherein the one or more computer programs further include computer-executable instructions that, when executed by the one or more processors individually or collectively, cause the management server to generate the first buffer for storing the first data based on identifying the change event.

9. The electronic system of claim 1, wherein the one or more computer programs further include computer-executable instructions that, when executed by the one or more processors individually or collectively, cause the management server to obtain the snapshot data from the backup image based on suspending the processing on the first data stored in the first buffer.

10. The electronic system of claim 1, wherein the change event includes a policy change related to the private information.

11. A method for managing an electronic system by a management server, the method comprising:
identifying, by the management server, a change event related to private information stored in a data warehouse of the electronic system;
extracting, by the management server, first data required to be changed according to the change event in data including the private information stored in a database of the electronic system based on the change event being identified;
storing, by the management server, the first data in a buffer corresponding to a first table of the data warehouse and a first buffer corresponding to a first warehouse table of the data warehouse and suspending processing on the first data stored in the first buffer;
performing, by the management server, processing on snapshot data obtained from a backup image of the data including the private information and storing the processed snapshot data in the first warehouse table of the data warehouse;
based on the processed snapshot data being stored in the first warehouse table, performing, by the management server, processing on the first data stored in the first buffer and updating the first warehouse table based on the processed first data; and
based on the first data stored in the first buffer meeting a designated condition after the processing on the first data is performed, replacing, by the management server, the first table with the first warehouse table.

12. The method of claim 11,
wherein the replacing of the first table with the first warehouse table includes changing a pointer of a virtual table for a user to identify information stored in the data warehouse to the first warehouse table instead of the first table, and
wherein the method for managing the server further comprises deleting resources for the first table.

13. The method of claim 11, further comprising, based on a number of the first data stored in the first buffer being smaller than a designated value after the processing on the first data is performed, identifying that the designated condition is met.

14. The method of claim 11, wherein performing the processing on the first data includes filtering or masking the private information stored in the first data if the backup data is stored in the first warehouse table.

15. One or more non-transitory computer-readable storage media storing one or more computer programs including computer-executable instructions that, when executed by one or more processors of a management server of an electronic system individually or collectively, cause the electronic system to perform operations, the operations comprising:
identifying, by the management server, a change event related to private information stored in a data warehouse of an electronic system by a management server of the electronic system;
extracting, by the management server, first data required to be changed according to the change event in data including the private information stored in a database of the electronic system based on the change event being identified;
storing, by the management server, the first data in a buffer corresponding to a first table of the data warehouse and a first buffer corresponding to a first warehouse table of the data warehouse and suspending processing on the first data stored in the first buffer;
performing, by the management server, processing on snapshot data obtained from a backup image of the data including the private information and storing the processed snapshot data in the first warehouse table of the data warehouse;
based on the processed snapshot data being stored in the first warehouse table, performing, by the management server, processing on the first data stored in the first buffer and updating the first warehouse table based on the processed first data; and
based on the first data stored in the first buffer meeting a designated condition after the processing on the first data is performed, replacing, by the management server, the first table with the first warehouse table.

16. The one or more non-transitory computer-readable storage media of claim 15,
wherein the replacing of the first table with the first warehouse table includes changing a pointer of a virtual table for a user to identify information stored in the data warehouse to the first warehouse table instead of the first table, and
wherein the operations further comprise deleting resources for the first table.

17. The one or more non-transitory computer-readable storage media of claim 15, further comprising, based on a number of the first data stored in the first buffer being smaller than a designated value after the processing on the first data is performed, identifying that the designated condition is met.

18. The one or more non-transitory computer-readable storage media of claim 15, wherein the performing of the processing on the first data includes filtering or masking the private information stored in the first data if the backup data is stored in the first warehouse table.

19. The one or more non-transitory computer-readable storage media of claim 15, wherein the management server filters or masks the private information stored in the first data based on the backup data being stored in the first warehouse table.

20. The one or more non-transitory computer-readable storage media of claim 19, wherein the management server provides the first data including the filtered or masked private information to the first warehouse table.
